(19) United States
(12) Patent Application Publication
(10) Pub. No.: US 2004/0187387 A1
(43) Pub. Date: Sep. 30, 2004

(54) Device for closing a building or enclosure and drive device and control device and control therefor

(76) Inventor: Matthias Hedrich, Bielefeld (DE)

Correspondence Address: STEVENS DAVIS MILLER & MOSHER, LLP, 1615 L STREET, NW, SUITE 850, WASHINGTON, DC, 20036, US

(21) Appl. No.: 10/484,767

(22) PCT Filed: Jul. 24, 2002
(86) PCT No.: PCT/DE02/02719

(30) Foreign Application Priority Data
Jul. 26, 2001 (DE) 101 35 413.4

(51) Int. Cl. E05F 15/20

(52) U.S. Cl. 49/25

(57) ABSTRACT

The invention relates to a building or security closure device (2), more particularly door (2), included a wing (3) powered by a motor assembly (23) and a monitoring or controller means (15) for controlling or monitoring travel of the door leaf (3), the monitoring or controller means (15) comprising a first, stationary electrotechnical unit (12, 13) and a second movable electrotechnical unit (5-10, 16) traveling with the wing (3) for communicating with the stationary unit (12, 13). To simplify installation and maintenance of the device, lengthen its useful life, reduce its costs of production and installation and in avoiding the negative consequences of faulty installation it is proposed in accordance with the invention that an energy transducer means (1, 9) is provided for transducing energy applied wireless on said wing, preferably non-electrical energy, more particularly mechanical energy and/or radiation energy into electrical energy, such as current and/or voltage, said transducer means being mounted on the wing (3) for energy supply of said traveling second electrotechnical unit (5-10, 16) and that a transmitter/receiver system (17) is provided for wireless communication of the two units (12, 13; 5-10, 16). The invention relates in addition to an operator as well as to a controller means for such a powered building or security closure device.

The invention relates to a device for closing a building or enclosure as set forth in the preamble of the attached claim 1, to a drive device as it reads from the preamble of the attached claim 2, for such a building or enclosure closing device, as well as to a control device as it reads from the preamble of the attached claim 3 for sensing and/or controlling such a drive device.

Such devices are already known, for example, in conjunction with commercially available powered doors. For controlling and monitoring known doors electrotechnical components are employed already mounted on the door leaf. These electrotechnical components are assigned a control device, for instance the controller of an operator. These are often configured as connecting devices of sensors or similar detecting means for monitoring motion of the wing, more particularly for detecting moving against an obstacle. This involves, for example, any kind of known closing edge sensor. Therein, a compressible rubber tubing, in the interior of which a light barrier in the form of an optosensor is located, is used at the lower closing edge. Compression of the rubber tubing by an obstacle on closing is sensed by the light barrier. In such case, the operator shall either instantly be halted or reversed or be prevented from becoming operative at all.

In variably when controllers or detectors are directly mounted on the door leaf or any other powered wing of a building or security closure, as is often highly desirable for safety reasons, there is also the necessity of electrically powering these sensors or similar control units whilst also ensuring signal communication to the operator controllers usually mounted stationary. For this purpose, the stationary and the traveling electrotechnical units on known doors or like closures are interconnected either hard-wired or by slide contacts. Wires or slide contacts are, for one thing, expensive, for another, susceptible to wear and tear by their slaved motion and are often problematic or bulky to mount. Faulty contact in mounting may result in one or other electrotechnical unity, especially an electronic unit, being ruined.

It is an object of the invention to simplify a device as it reads from the preambles of the attached independent claims with regard to its installation and maintenance. Further objects of the invention are to lengthen the useful life of the device, to reduce the costs of its production and installation, and to avoid the negative consequences due to faulty installation.

These objects are achieved by devices as set forth in the independent claims 1, 2 or 3.

Advantageous aspects of the invention are subject matter of the sub-claims.

In accordance with the invention, powering the traveling electrotechnical unit is preferably now no longer provided hard-wired as hitherto. Instead, the traveling electrotechnical unit has its own power supply in the form of an energy transducer. This converts the (non) electrical energy existing on the wing or applied without electrical contact thereto into energy for electrical utilization on the wing.

For example, since the door leaf is driven, mechanical work also takes place on the door and is converted into motional energy. In one advantageous aspect, the motional energy can be easily converted into electrical energy by a generator, dynamo or the like. This solution is particularly simple on doors such as sectional doors or other up and over doors already featuring rollers for smooth running. Such a roller can be assigned a dynamo—e.g. available as a mass production item which is powered by the motion of the roller.

Another possibility of powering the wing-mounted electrotechnical unit wireless is to convert radiant energy into electrical energy, for example by solar cells (photovoltaics) or the like. Such radiant energy transducers exploit either ambient light, or radiant energy is communicated from outside to the energy transducer, for example by beaming, induction or radio waves. It is just as conceivable, however, to communicate AC power to the door leaf by contactless inductive or capacitive coupling with the closure closed and to buffer or store it there for powering the traveling units.

Connecting the two controllers (first and second electrotechnical unit) is likewise by wireless means. This is done preferably via RF communication since common door operators nowadays have an RF receiver integrated in their controller for signalling opening and/or closing the door by a handheld transmitter. Such a receiver may also be used in configuring a transponder system by means of which the stationary unit can be connected to the traveling unit by RF communication or the like (infrared, etc).

In accordance with another advantageous aspect of the invention it is provided for that the transponder system comprises a first receiver also suitable for receiving control commands from a user transmitter—e.g. handheld transmitter for opening the closure and which is assigned to the first electrotechnical unit. The first receiver is more particularly located stationary. Advantageously, it is formed by the receiver of commercially available remote- controlled operators. In accordance with this advantageous aspect of the invention this first receiver is also used to receive signals transmitted by the second electrotechnical unit traveling together with the wing. This may be a signal indicating activation of an edge sensor guard.

However, not only the stationary first, also the traveling second electrotechnical unit, may be assigned a receiver. One such second receiver has the advantage that the traveling unit can be signalled from the stationary location or by remote control. The communication between the individual stationary and traveling units of the devices in accordance with the invention can also be configured to advantage in making use of Bluetooth wireless technology.

The electrotechnical units are preferably formed by means for sensing, controlling, monitoring, analyzing and/or powering means for motor apparatusses and detector means such as sensors or the like, or feature such means. As a rule they comprise one or more circuit boards on which the individual means are achieved in the form of electronic circuits and/or hardware/software combinations—e.g. programmed or programmable microprocessors.

The second electrotechnical unit comprises preferably a second sensing, controlling or powering unit for sensing, controlling and/or powering a sensor traveling with the wing. Preferably this traveling second electrotechnical unit comprises an analyzing circuit for such a sensor. Sensors of this kind may be mounted on the wing for various purposes. Apart from the said closing edge sensor, detecting means may be provided for sensing obstacles in the path of the wing e.g. optically, for instance by infrared means, or acoustically, by means of ultrasonic means. For example, sensors the same or similar to those used to assist parking on advanced motor vehicles. But also, wind pressure sensors or other ambient sensors, feelers detecting the closed status of an escape door in the wing, position sensors for sensing the position of the wing at any one time, etc may be mounted traveling on the wing and connected to the second electrotechnical unit.

Particularly preferred is an aspect in which the power requirement of the traveling second electrotechnical unit is optimized. When its power consumption is low, not much power needs to be transmitted to the door leaf and low-cost, miniaturized energy transducers suffice which have no appreciable influence on the motion of the wing. Accordingly, the second electrotechnical unit is selected and configured so that its power consumption is at a minimum. For an operating voltage of 24 V, for example, the long-term current flow is designed to be but a few μA. This is achieved in one advantageous aspect by the second electrotechnical unit being signal-enabled from a disabled status. In the disabled status all electrical or electronic components of the second electrotechnical unit with the except of a receiver in the connecting means—as well as any power supplies such as solar cells—are disabled. In the disabled status the power consumption of the second electrotechnical unit is less than 10 mW, preferably less than 100 μW, even more preferably less than 10 μW. Further preferably provided are means for enabling the second electrotechnical unit by the second receiver from the disabled status when the second receiver receives a wireless signal of a stationary or mobile transmitter in thus enabling the traveling electrotechnical unit to be remotely activated.

In another particularly preferred aspect, the second receiver enables the second electrotechnical unit when receiving a signal emitted for initiating or changing the motion of the operator by the transmitter assigned to the user. The signal emitted, for example, for opening or closing a door—as may originate in a handheld transmitter, key switch or interior switch, etc.—is transmitted by RF or similar wireless communication for instant detection by the second receiver traveling on the wing and assigned to the second electrotechnical unit, and sets the latter in said enabled status. The second electrotechnical unit then activates all sensors and the like units traveling on the wing and to be controlled and/or monitored and eventually analyzes their signals and/or relays them on for further use. All components of the second electrotechnical unit are thus preferably activated in the active or enabled status.

With many closures it is only the closing motion that is critical, it only being then that there is a risk of obstacles or persons being trapped. In such cases it is of advantage in saving energy when the enable signal is a signal starting a closing motion of the wing. The traveling electrotechnical unit then remains disabled or in standby modus when the wing is idle and when the wing is opened. It is not until the operator receives a command to close the wing that this command is also employed directly or indirectly to enable or activate the second electrotechnical unit which then remains enabled or achieve during the running of the closing motion. Also conceivable is an intermediate status of the second electrotechnical unit in which namely only the components needed for the opening motion are enabled. This intermediate status would then be enabled by an opening signal and the enabled status activated by the closing signal. Instead of this, an enabled status relevant specifically only for the closing motion could be instigated in which only the components needed for the closing motion are enabled, but not those as needed exclusively for sensing the opening motion.

The second electrotechnical unit may also be automatically disabled on time-out of the wing motion, for example. This may also be programmed to occur on transmission of a disable signal emitted on conclusion of the motion of the first electrotechnical unit.

So that the power supply of the second electrotechnical unit which may be relevant for safety reasons, is assured even when the energy transducer furnishes no or insufficient energy, an energy storage device for storing and/or buffering the electrical energy furnished by the energy transducer is of advantage.

Instead of, or in addition to, the energy transducer a power supply may also be provided comprising an energy storage device designed for traveling in or on the wing as well as a connecting and/or charging station, configured and to be stationary located so that when the wing has travelled to an end position it can be brought into contact with the energy storage device and/or the second electrotechnical unit for powering the latter. For example, contacts may be provided at the surrounding of the wing which engage matching contacts on the wing when the wing is closed or fully open. Thereby, power can be communicated, when the wing stands still, for storage in the energy storage device for powering the traveling units during motion of the wing. This solution ensures a power supply and thus operation of the traveling units even over lengthy periods of time; but this is less preferably because of the added complications of installation and the additional costs. Additionally, the contacts are subjected to wear. However, when employing the inductive or capacitive noncontactive coupling as described above instead of the contacts, this aspect could be highly interesting for applications demanding enhanced safety.

The energy storage device comprises preferably at least one capacitor, more particularly a goldcap, and/or an accumulator. In addition or as an alternative thereto the energy storage device may also comprise a battery or a battery unit composed of a plurality of batteries. The operating voltage of the electrotechnical units traveling with the wing is preferably adapted to the energy storage device, for example to the voltage of the accumulator, the (rechargeable) battery or battery unit. Since there is no permanent electrical connection, there is no need for this voltage to agree with the operating voltage of the stationary electrotechnical units.

Preferably a transmitter is provided exclusively for signalling and enabling the electrotechnical units arranged on the wing. It is basically possible that these units respond to corresponding door travel signals beamed from a handheld transmitter or the like for their activation. However, a special transmitter, which is activated e.g. by the stationary unit every time before initiating wing travel to emit a signal for enabling the traveling units, has advantages as regards receiver sensitivity, secure communication, free selection of the frequency range as well as the admissible length and free selection of a personalized code in preventing unauthorized use. When the separate special transmitter is capable of reacting to a test output of a master controller provided for testing and/or initializing connected units, one is compatible with existing systems implementing such testing for safety reasons every time before the door is travelled.

A preferred embodiment of the invention will now be detained with reference to the attached drawings in which:

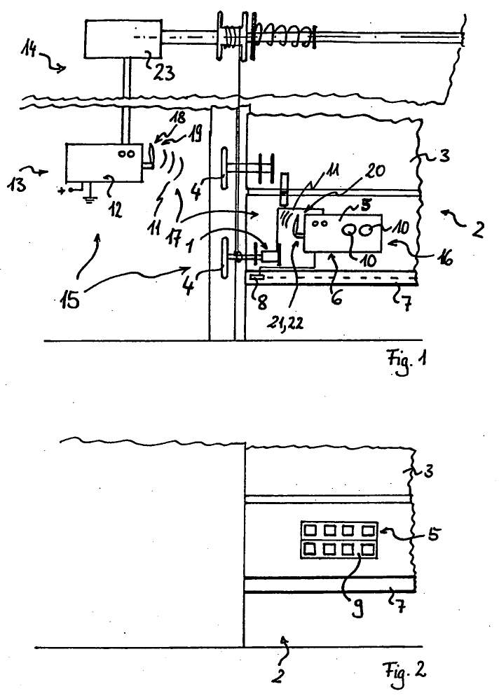

FIG. 1 is a diagrammatic rear view of a powered closure device for enclosures or buildings, here in the form of a sectional door; and

FIG. 2 is front view of the sectional door as shown in FIG. 1.

The figures show views of a power driven closure device for buildings or enclosures by way of a sectional door 2 as an example including a drive device in the form of a door operator 14—as a jackshaft operator in this case. The door operator 14 is controlled by a controller in the form of a door operator controller 15 which also monitors travel of the driven wing of the building closure, i.e. in this case the door leaf 3. The operator controller 15 has a first stationary electrotechnical unit, formed mainly by a master controller 13 mounted on the wall alongside the doorway, and a traveling second electrotechnical unit secured to the door leaf 3 and serving for controlling, powering, analyzing, sensing or for forming detecting means traveling on the door leaf 3. The second electrotechnical unit in this case is mainly formed by a control and analyzer circuit 16, mounted on the door leaf, for a safety means at the closing edge.

In contemplating traveling operation of the electrotechnical units or components on the door leaf 3 (sectional door, roller door, swing door, up and over door, etc) there is always the problem of supplying these units, components, or their electrical or electronic parts. For this purpose either spiral or festoon power feeders or sliding contact pickoff systems are currently available.

By contrast, the sectional door 2 illustrated in this case features an energy transducer for converting energy, which is applied to the door leaf 3 or is non-electrical, into an electrical energy for power supply. In one embodiment this is a miniature motor, for instance a stepper motor, operated as a generator 1 mounted on the door leaf 3 of the sectional door 2 on the bottomost roller 4. Travel of the door leaf 3 rotates the roller 4 and generates electrical energy in the generator 1. Further provided in a controller housing 5 mounted on the door leaf 3 is the control and analyzer circuit 16 having a power supply means 6 for supplying an closing edge safety means 7 having an optosensor 8 with voltage prior to activation of the operator 14.

In the embodiment as shown a further energy transducer means is achieved via a small solar panel 9 accommodated on the outside or in the cover of the controller housing 5. The energy supplied by one or both of the transducer means 1, 9 is stored by an energy storage device, in this case goldcaps 10, i.e. special high-performance capacitors. As an alternative or in addition thereto the energy storage device may comprise one or more rechargeable batteries (not shown) and/or batteries (likewise not shown). Thus it is possible to apply a radio signal to an analyzer 12 of the master controller 13 even if the closing edge safety means 7 is activated prior to travel of the door leaf 3 so that the master controller 13 is prevented from commanding the operator 14 to start.

When the door leaf 3 is travelled unobstructed the energy from the roller 4 and the fitted or integrated generator 1 is communicated to the goldcaps 10 and/or at least one rechargeable battery where it is correspondingly buffered on each up and down travel. Thus, it is possible to operate without the nuisance of a direct connection between the door frame or the building/wall and the travelled door leaf 3. This is of course applicable to all kinds of doors or other building or security closures.

The communication between the first and second electrotechnical unit 13, 16 is made by a wireless means of communication. This means is formed by a wireless transmitter-receiver-system 17 communicating in this case via radio communication 11. For this purpose, the first electrotechnical unit, i.e. the stationary master controller 13, features a first receiver 18. The first receiver 18 is designed for receiving command signals from a handheld transmitter (not shown) with which the sectional door 2 can be remote opened and/or closed, and for receiving signals from the control and analyzer circuit 16. Connected to the master controller 13 is further a first transmitter 19 for transmitting control or interrogating signals to the control and analyzer circuit 16.

The traveling control and analyzer circuit 16 is connected to a second transceiver 20 mounted on the door leaf 3 having a second receiver 21 and a second transmitter 22. The second receiver 21 receives the control and interrogation signals emitted by the first transmitter 19. The second receiver could also be configured to receive signals for commanding the handheld transmitter. The second transmitter 22 emits signals to the master controller 13 for this to indicate at least one status as sensed by the sensor means. The second transmitter 22 mainly serves to signal a handshake when none of the sensors connected to the control and analyzer circuit 16 senses a condition in which door travel is prohibited. In addition or as an alternative thereto the second transmitter 22 could also communicate a stop signal to the master controller 13 when such a condition is detected.

The transmitter receiver system 17 is configured at least two-channel. The first channel communicates an activating signal for door travel, i.e. for example the signal for commanding “door UP” or “door DOWN”. The second channel is assigned to a closed break circuit. In a break circuit incorporated in the door leaf 3 a various detecting means are connected in series detecting required conditions which must be satisfied before door travel can be initiated. Should any one of the requirements not be satisfied, the break circuit is open. The embodiment as discussed presently will only send the handshake when this break circuit is closed. The master controller 13 implements door travel only when and as long as it receives the handshake. Should receiving the handshake be discontinued, the master controller 13 halts the motor 23 of the operator 14 and/or reverses it. In addition to the optosensor 8 of the edge sensor guard 7 such detecting means may also be, for example, (not shown) an escape door contact signalling the closed status of an escape door (not shown) in the door leaf 3.

In the present preferred embodiment permitting remote-control via a handheld transmitter, the first receiver has in addition a third channel for receiving control commands of the handheld transmitter, in other words is configured with at least three channels.

The electrotechnical components mounted traveling on the door leaf 3 can be switched between an inactive or disabled status and an active or enabled status as required. In the disabled status, practically all of the electrical consumers are OFF, except for the second receiver 21 which is ready to receive the enabling or activating signals. In the disabled status (or standby modus) the solar panel 9 also furnishes energy in accordance with irradiation, which energy is stored in the goldcaps 10 and/or rechargeable batteries. Therefore, in the disabled status current consumption is a minimum, resulting in a positive energy balance on an average with corresponding irradiation. For example, the current consumption of the control/analyzer circuit 16 in the disabled status is in the μA range. This is achieved by an energy-optimized microcontroller correspondingly programmed to form the control/analyzer circuit 16.

Should the second receiver 21 in the disabled status receive a corresponding control signal from the master controller 13, the control/analyzer circuit 16 instantly changes from the disabled to the enabled status in powering all detecting means 7, 8 and sending the handshake when the break circuit is closed. In an embodiment (with no escape door) this change is made only on receiving the signal “door DOWN” and not when the signal is “door UP”, since signals of the closing edge sensor are only of interest in DOWN travel of the door. In response to a signal of the master controller 13 indicating end of travel or timeout thereof, in which door travel is normally excluded with the inclusion of a safety margin, the control/analyzer circuit 16 automatically signals the change from the enabled status to the disabled status.

The operation of the sectional door is described in the following. When the door leaf 3 stands still, the goldcaps 10 and/or rechargeable batteries are charged by the solar panel 9, the control/analyzer circuit 16 and all components connected thereto (e.g. optosensor 8) are disabled whilst the second receiver 21 is on standby. On actuation of the handheld transmitter the “door UP” or “door DOWN” operator signal is received by the first receiver 18 of the operator controller 15. This activates the master controller 13 which sends via the first transmitter 19 a corresponding control signal “door UP” or “door DOWN” to enable the traveling or other remote mounted electrotechnical units, especially the control/analyzer circuit 16, and then constantly tests whether the handshake has been received. The control/analyzer circuit 16 is enabled, energizes the detector means 7, 8 connected in series in the break circuit and returns the handshake when the break circuit is closed. The energy is supplied by the goldcaps 10 and/or rechargeable batteries. On receiving the handshake the master controller 13 enables the motor 23 prompting it implement door travel. Should, however, one of the detector means 7, 8 sense a prohibitive status (examples: escape door open, closing edge sensor not free) the break circuit is open, the control/analyzer circuit 16 outputs no handshake or instantly discontinues communication of the handshake. This is why door travel is not even commenced or it is halted and/or reversed in case of fall away of the handshake. Implementation of door travel powers the roller which powers the generator 1. The generator 1 then generates energy just when the control/analyzer circuit 16 is enabled in thus having a higher power requirement than when disabled.

The signal activating the control/analyzer circuit 16 (termed above “door UP” or “door DOWN”) is beamed in this case by the first transmitter 19 connected to the master controller 13 to the second receiver 21 of the control/analyzer circuit 16. This is always the case before the master controller 13 automatically initiates door travel on receiving a corresponding command, for instance, when a user actuates his assigned actuating device for the command “door UP” or “door DOWN”. This may be, apart from a handheld transmitter communicating with the master controller 13, a switch, for example, an internal, code, key, contact threshold, proximity or remote-type switch and the like wired to the master controller 13 or otherwise connected thereto (e.g. via Bluetooth wireless technology, monitoring systems, etc). For this purpose the first transmitter 19 is connected to a test operator of the master controller 13 provided to test the connected safety devices for proper functioning prior to door travel.

### List of Reference Numerals

1 generator (energy transducer means)

2 sectional door (closing device for buildings or enclosures)

3 door leaf (wing)

4 roller

5 controller housing

6 supply means

7 closing edge safety means

8 optosensor

9 solar panel (energy transducer means)

10 goldcap

11 radio communication

12 analyzer

13 master controller (stationary first electrotechnical unit)

14 door operator (drive device)

15 operator controller (controller device)

16 control/analyzer circuit (traveling second electrotechnical unit)

17 transmitter receiver system

18 first receiver

19 first transmitter

20 transceiver

21 second receiver

22 second transmitter

23 motor

In the claims

1. A closure device for buildings or enclosures, more particularly door, including a wing driven by a motor assembly and a controller device for controlling and monitoring travel of the door leaf, said controller device comprising a first, stationary electrotechnical unit and a second, movable electrotechnical unit arranged and traveling on said wing and able to communicate with said stationary unit wherein for powering said movable second unit an energy transducer means is provided for transducing energy applied wireless, to said wing, preferably non-electrical energy, more particularly mechanical energy and/or radiation energy, into electrical energy, such as current and/or voltage, said energy transducer means being mounted on said door leaf and a transmitter/receiver system is provided for wireless communication of said two units.

2. A drive device for operating a wing of a closure for a building or an enclosure including
a motor assembly for driving said wing and
a controller device for controlling and monitoring said motor assembly and/or the resulting motion of said wing, comprising:
a first electrotechnical unit assigned to said motor assembly for stationary mounting,
a second electrotechnical unit for mounting on said wing, and
a communication and connecting means for intercommunication of said two electrotechnical units,
wherein
said communication and connecting means is wireless, more particularly a transmitter/receiver system, and an energy transducer means is provided for mounting on said wing to supply said second unit with energy, wherein said energy transducer means transduces energy which is applied wireless to said wing, preferably non-electrical energy, more particularly mechanical energy and/or radiation energy into electrical energy, such as current and/or voltage.

3. A controller device for monitoring and controlling of a motorized driven travel of a wing of a closure for a building or an enclosure comprising
a stationary mounted first electrotechnical unit assigned to a motor assembly
a second electrotechnical unit mounted on said wing
wherein
an energy transducer means mountable on said wing is provided for energy supply of said second electrotechnical unit, said transducer means transducing energy which is applied wireless to said wing, preferably non-electrical energy, more particularly mechanical energy and/or radiation energy into electrical energy, such as current and/or voltage.

4. The controller device as set forth in claim 3, comprising a wireless communication and connection means, more particularly a transmitter/receiver system for signal communication between said two units.

5. The device as set forth in claim 1, wherein said transmitter/receiver system is a radio communication system.

6. The device as set forth in claim 1, wherein said transmitter/receiver system comprises a first receiver suitable also for receiving control commands from a user-assigned transmitter, such as a handheld transmitter, for opening said closure, said first receiver being assigned to said first electrotechnical unit.

7. The device as set forth in claim 1, wherein said transmitter/receiver system comprises a second receiver suitable for receiving control commands from a stationary transmitter or from a user assigned transmitter, such as a handheld transmitter for opening said closure, said second receiver being assigned traveling to said second electrotechnical unit traveling on said wing.

8. The device as set forth in claim 1, wherein said first electrotechnical unit is or comprises a first monitoring or controller unit for monitoring and/or controlling at least one stationary assembly of said operator for said wing.

9. The device as set forth in claim 1, wherein said second electrotechnical unit is or comprises a second monitoring, controlling or supplying and/or analyzing unit for monitoring, controlling, supplying and/or analyzing a sensor traveling on said wing or the like detecting means traveling on said wing for detecting of conditions of the wing and/or ambient conditions of the wing, more particularly, the travel of said wing and/or for analyzing the signals of such a sensor or such a detecting means respectively.

10. The device as set forth claim 1, wherein said second electrotechnical unit serves for securing a closing edge.

11. The device as set forth in claim 1, wherein said second electrotechnical unit can be switched from a disabled status to an enabled status by an activating signal, all electrical consumers of said second electrotechnical unit except for a receiver part of said communication and connection means being disabled in said disabled status so that said second electrotechnical unit has a power consumption of less than 10 mW, preferably less than 100 μW, more preferably less than 10 μW.

12. The device as set forth claim 7, wherein said second receiver can set said second electrotechnical unit from said disabled status in an enabled status, when said second receiver receives a wireless communicated enable signal of a stationary or mobile transmitter.

13. The device as set forth in claim 6, wherein said second receiver activates said second electrotechnical unit on receiving an activating signal emitted by said first transmitter before initiating motion of said motor assembly.

14. The device as set forth in claim 13, wherein said first transmitter is connected to a testing output of said monitoring or controller means serving to test connected units before initiating a motion, for sending said enable or activating signal in the course of the test procedure.

15. The device as set forth in claim 11, wherein said second electrotechnical unit is switched from the enabled status into said disabled status automatically on timeout and/or by a disable signal transmitted by said first electrotechnical unit on completion of travel.

16. The device as set forth in claim 1, wherein said second electrotechnical unit comprises an energy storage device for storing and/or buffering electrical energy supplied preferably by an energy transducer means.

17. The device as set forth in claim 1, wherein instead of or in addition to said energy transducer means a power supply is provided comprising an energy storage means intended for traveling on or at said wing as well as a connecting and/or charging station configured and stationary arranged such that when said wing is at the end of its travel said energy storage means and/or said second electrotechnical unit can supply energy preferably contactless by inductive and/or capacitive coupling.

18. The device as set forth in claim 16, wherein said energy storage means comprises at least one capacitor, more particularly a goldcap capacitor, at least one rechargeable battery and/or at least one battery.

19. The device as set forth in claim 1, wherein said energy transducer means comprises a generator means powered by travel of said wing.

20. The device as set forth in claim 19, wherein said generator means is provided on a roller existing or additionally mounted on said wing for converting motion of said roller on travel of said wing into electrical energy.

21. The device as set forth in claim 1, wherein said energy transducer comprises a photovoltaic unit.
